(19) United States
(12) Patent Application Publication
(10) Pub. No.: US 2021/0374711 A1
(43) Pub. Date: Dec. 2, 2021

(54) INFORMATION PROCESSING SYSTEM, SERVER, AND COMPUTER READABLE RECORDING MEDIUM

(71) Applicant: TOYOTA JIDOSHA KABUSHIKI KAISHA, Toyota-shi (JP)

(72) Inventors: Shintaro MATSUTANI, Kariya-shi (JP); Misato YOKOTA, Tokyo (JP); Yumiko OSAKI, Tokyo (JP); Atsushi YONEKI, Chigasaki-shi (JP); Kazunari TSUTSUMI, Tokyo (JP); Mitsunori ISODA, Tokyo (JP); Yuzo YAMADA, Nagoya-shi (JP)

(73) Assignee: TOYOTA JIDOSHA KABUSHIKI KAISHA, Toyota-shi (JP)

(21) Appl. No.: 17/237,406

(22) Filed: Apr. 22, 2021

(30) Foreign Application Priority Data
Jun. 1, 2020 (JP) 2020-095735

(51) Int. Cl. G06Q 20/22; G06Q 20/14; G06Q 20/36

(52) U.S. Cl. CPC G06Q 20/29; G06Q 20/367; G06Q 20/14

(57) ABSTRACT

An information processing system includes: a first terminal including a first processor including hardware; and a server including a second processor including hardware, wherein the first processor is configured to output, to the server, a calculation request for calculating a split bill amount for each user in a case where an expense is split to a plurality of users using electronic money deposited in an electronic wallet of each of the plurality of users, and the second processor is configured to calculate, in response to the calculation request, a split bill amount for each of the plurality of users based on user information of the plurality of users, and output information about the calculated split bill amount to the first terminal.

The present application claims priority to and incorporates by reference the entire contents of Japanese Patent Application No. 2020-095735 filed in Japan on Jun. 1, 2020.

### BACKGROUND

The present disclosure relates to an information processing system, a server, and a computer readable recording medium.

JP 2016-151785 A discloses a technique that enables an electronic settlement by splitting the bill by making payments using credit cards by a plurality of users.

### SUMMARY

When the expense of drinking and eating occasion in which multiple people participate is paid by someone and reimbursed, it is complicated to identify the participants and collect money from the participants.

There is a need for an information processing system, a server and a computer readable recording medium that facilitate collection of money from participants when the organizer pays an expense and gets the expense reimbursed.

According to one aspect pf the present disclosure, there is provided an information processing system including: a first terminal including a first processor including hardware; and a server including a second processor including hardware, wherein the first processor is configured to output, to the server, a calculation request for calculating a split bill amount for each user in a case where an expense is split to a plurality of users using electronic money deposited in an electronic wallet of each of the plurality of users, and the second processor is configured to calculate, in response to the calculation request, a split bill amount for each of the plurality of users based on user information of the plurality of users, and output information about the calculated split bill amount to the first terminal.

### BRIEF DESCRIPTION OF THE DRAWINGS

FIG. 1 is a schematic diagram illustrating a schematic configuration of an information processing system according to an embodiment;

FIG. 2 is a block diagram illustrating functional blocks of the information processing system according to the embodiment;

FIG. 3 is a sequence diagram illustrating a control flow for determining a split bill amount of an expense for each of a plurality of participants;

FIG. 4 is a sequence diagram illustrating money transfer processing from a participant; and

FIG. 5 is a sequence diagram illustrating a progress confirmation flow of a money collection state.

### DETAILED DESCRIPTION

Hereinafter, a server, an information processing system, and a computer readable recording medium storing a program according to an embodiment will be specifically described with reference to the drawings. The present disclosure is not limited to the embodiment described below.

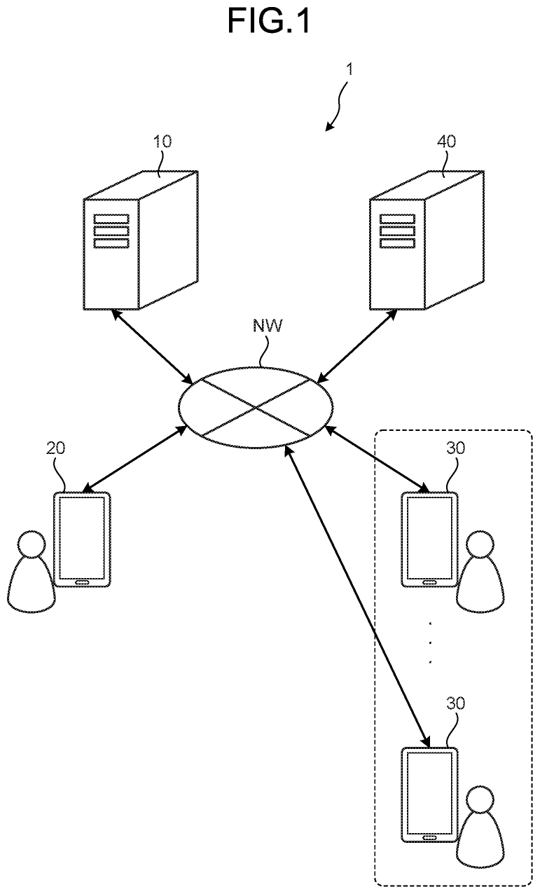

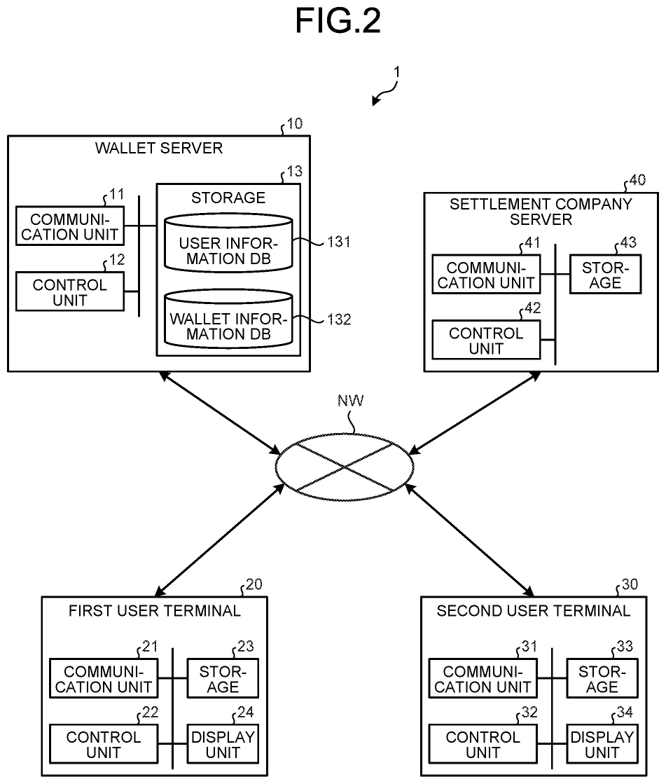

The configuration of the information processing system according to the embodiment will be described with reference to FIGS. 1 and 2. As illustrated in FIG. 1, an information processing system 1 of the embodiment includes a wallet server 10, a first user terminal 20, second user terminals 30, and a settlement company server 40.

In the information processing system 1, the wallet server 10, the first user terminal 20, the second user terminals 30 and the settlement company server 40 are configured to be able to communicate with each other through a network NW. The network NW includes, for example, the Internet line network, a mobile phone line network, and the like.

The wallet server 10 is a server that collectively manages a wallet system, and is managed by an administrator of the wallet system. As illustrated in FIG. 2, the wallet server 10 includes a communication unit 11, a control unit 12, and a storage 13.

The communication unit 11 includes, for example, a Local Area Network (LAN) interface board, a wireless communication circuit for wireless communication, and the like. The communication unit 11 is connected to the network NW such as the Internet, which is a public communication network, or the like. The communication unit 11 communicates with the first user terminal 20, the second user terminals 30, and the settlement company server 40 by connecting to the network NW.

The control unit 12 includes a processor and a memory. The processor includes a central processing unit (CPU), a digital signal processor (DSP), a field-programmable gate array (FPGA), and the like. The memory is a main storage device, and includes a random access memory (RAM), a read only memory (ROM), or the like. The control unit 12 loads a program stored in the storage 13 into the work area of the memory (main storage device) and executes the program, and controls each of the components and the like through the execution of the program to implement functions that meet a predetermined purpose.

The storage 13 includes a recording medium such as an erasable programmable ROM (EPROM), a hard disk drive (HDD), and a removable medium. Examples of the removable medium include a disc recording medium such as a universal serial bus (USB) memory, a compact disc (CD), a digital versatile disc (DVD), and a Blu-ray (registered trademark) disc (BD). The storage 13 may store an operating system (OS), various programs, various tables, various databases (DB), and the like. The storage 13 includes a user information database 131 and a wallet information database 132.

In the user information database 131, information about a user who uses the wallet system (hereinafter, referred to as “user information”) is stored. Examples of the user information include the user ID, password, user name, user contact information (for example, an address, a telephone number, an email address, etc.), a usage registration history, information about a payment method registered as a deposit method, information about a payment method registered as a settlement method, a code number at the time of settlement, and the like of a user who has registered to use the wallet system. Out of the user information, the user ID and the password are used for authentication processing such as login to the wallet server 10.

In the wallet information database 132, information about electronic wallets of the wallet system (hereinafter, referred to as “wallet information”) is stored. Examples of the wallet information include a user ID, an electronic money balance, an electronic money deposit history, an electronic money usage history, and the like. Further, in the wallet information database 132, information about settlement in the wallet system (hereinafter, referred to as “settlement information”) is stored. Examples of the settlement information include a user ID, a settlement method used for settlement (for example, electronic money payment, scan payment, code payment, etc.), a settlement history, and the like. Here, electronic money settlement is contactless settlement.

For example, an electronic wallet associated with the first user who owns the first user terminal 20 is a first electronic wallet. The wallet information about this first electronic wallet is stored in the wallet information database 132. Further, an electronic wallet associated with a second user who owns one of the second user terminal 30 is a second electronic wallet. The wallet information about this second electronic wallet is stored in the wallet information database 132. Then, the information processing system 1 is configured to enable money transfer of electronic money from the second electronic wallet associated with an organizer to the first electronic wallet associated with a participant other than the organizer.

Further, in the storage 13, information about the members who participated in the drinking and eating party, group information indicating a group to which the user belongs, information about a split ratio set for each group, and the like are stored. Further, in the storage 13, deposit confirmation information, progress information about the money collection state, reminder information for users who have not deposited, and the like are stored. Note that information about members who participated in the drinking and eating party and the like may be stored as schedule information in a server different from the wallet server 10. In short, the wallet server 10 may be configured such that the wallet server 10 may acquire schedule information regarding a drinking and eating party and the like. For example, the wallet server 10 may perform processing of calculating the split bill amount of the expense based on the schedule information and the group information stored in the server that manages the schedule.

The first user terminal 20 is a computer terminal used by the organizer as the first user. Examples of the first user terminal 20 include a smartphone, a mobile phone, a tablet terminal, a wearable computer, a personal computer, or the like used by the user. The first user terminal 20 is an organizer terminal used by the organizer.

The first user terminal 20 includes a communication unit 21, a control unit 22, a storage 23, and a display unit 24. The communication unit 21, the control unit 22, and the storage 23 included in the first user terminal 20 are physically similar to the communication unit 11, the control unit 12, and the storage 13 included in the wallet server 10. The first user terminal 20 may be any mobile terminal as long as it may transmit and receive information to and from the wallet server 10 via the network NW.

The control unit 22 functions as a display control unit, a deposit method registration unit, a settlement method registration unit, a deposit processing unit, and a settlement processing unit through the execution of a program stored in the storage 23.

When the control unit 22 functions as a display control unit, the control unit 22 controls the display content on the display unit 24. The control unit 22 displays various screens on the display unit 24 based on an operation (touch operation, flick operation, etc.) of a user. Examples of display screens include a login screen when logging in to the wallet system, a settlement screen when making a settlement by scan payment, etc., a usage history screen indicating a list of usage histories such as a settlement, a payment history detail screen indicating details of payment histories, a deposit screen when depositing electronic money in an electronic wallet. In addition, the control unit 22 transitions screen to screen based on an operation of a user.

When the control unit 22 functions as a deposit method registration unit, the control unit registers a deposit method for depositing electronic money. The deposit method indicates a method of depositing electronic money in an electronic wallet, which is a virtual deposit/withdrawal account. Examples of the deposit method include a bank account and a credit card out of the payment methods. By registering a bank account and a credit card as deposit methods, deposit of electronic money in an electronic wallet becomes possible. The payment method indicates a method that serves as a funding source when a settlement is made. Examples of the payment method include a bank account, a credit card, and an electronic money balance in an electronic wallet. A bank account is linked to the credit card, and a use amount of each card is withdrawn from the bank account at a later date.

The control unit 22 transmits, to the wallet server 10, a deposit method registration request asking for registration of a plurality of different payment methods operated by a plurality of companies as deposit methods to the electronic wallet. When the control unit 12 of the wallet server 10 receives a deposit method registration request from the first user terminal 20, the control unit 12 stores, as user information, the payment methods included in the deposit method registration request in the user information database 131 of the storage 13. As a result, the payment methods are registered in the user information database 131 as deposit methods.

When the control unit 22 functions as a settlement method registration unit, the control unit 22 registers the payment methods to be registered as deposit methods also as settlement methods. The “settlement method” indicates a method of making a settlement using a payment method. Examples of the settlement method include scan payment, electronic money payment, and code payment. All of the scan payment, the electronic money payment, and the code payment are settlement methods using the balance of the electronic money in the electronic wallet.

For example, the control unit 22 transmits a settlement request to the wallet server 10 or a store terminal for making a settlement using any of a plurality of preset settlement methods (electronic money payment, scan payment, code payment) using electronic money deposited in the electronic wallet. At that time, in a case where an electronic money payment is made, the control unit 22 transmits a payment request to the store terminal through the short-range wireless communication unit. A scan payment is a settlement made when a barcode or QR code (registered trademark) posted at a store is read with a camera or the like of the first user terminal 20. When a code payment is made, the control unit 22 transmits a payment request to the store terminal by having a reading unit such as the code reader or the like of the store terminal read a barcode or QR code (registered trademark) displayed on the first user terminal 20. When a scan payment is made, the barcode or QR code (registered trademark) displayed on the store terminal such as a cash register may be read by the first user terminal 20.

When the control unit 22 functions as a deposit processing unit, the control unit 22 deposits electronic money in an electronic wallet. The control unit 22 transmits a deposit request to the wallet server 10 for depositing electronic money in the electronic wallet by a payment method registered as a deposit method. When the control unit 12 of the wallet server 10 receives the deposit request from the first user terminal 20, the control unit 12 increases the electronic money balance in the electronic wallet based on deposit amount information included in the deposit request. That is, the control unit 12 updates the wallet information stored in the storage 13 according to the increased amount of the electronic money balance in the electronic wallet.

When the control unit 22 functions as a settlement processing unit, the control unit 22 makes a settlement by the payment method. For example, when a scan payment is made, the control unit 22 transmits a payment request (settlement request) to the wallet server 10 by reading a QR code (registered trademark) posted at the store with the camera or the like of the first user terminal 20.

When the control unit 22 functions as a settlement processing unit, the control unit 22 may also make a settlement by a payment method other than the electronic money balance in the electronic wallet (for example, a bank account or a credit card). For example, when a deposit method registration request is transmitted from the first user terminal 20 to the wallet server 10, the control unit 22 transmits a registration request, which causes the payment methods included in the deposit method registration request to be registered as settlement methods, to the wallet server 10. That is, when the control unit 22 registers, to the wallet server 10 as a deposit method, a payment method (for example, a bank account of bank X), the control unit 22 automatically registers the payment method (the bank account of bank X) also as a settlement method. “Registering a payment method as a settlement method” means making the payment method available as a payment source for settlement. In other words, it means making a scan payment possible using the bank account of bank X as the payment source. When the control unit 12 of the wallet server 10 receives a registration request from the first user terminal 20, the control unit 12 stores, as user information, the payment method included in the registration request in the user information database 131. Thus, the payment method is registered as a settlement method. Then, the control unit 22 transmits a payment request to the wallet server 10 for making a payment using any of a plurality of settlement methods by a bank account or a credit card. When the control unit 12 receives a payment request (settlement request) from the first user terminal 20, the control unit 12 transmits settlement amount information included in the payment request to the settlement company server 40. Then, the settlement processing is performed through information communication between the wallet server 10 and the settlement company server 40.

In the storage 23, data of various screens that the control unit 22 displays on the display unit 24 is stored. Further, in the storage 23, the user information, the wallet information, and the like are temporarily stored as needed.

The display unit 24 includes, for example, a touch panel display, and has an input function for accepting an operation by a user's finger, a pen, or the like, and a display function for displaying various types of information based on the control by the control unit 22.

The second user terminal 30 is a computer terminal used by a participant, other than the organizer, as the second user Examples of the second user terminal 30 include a smartphone, a mobile phone, a tablet terminal, a wearable computer, a personal computer, or the like used by the second user. Assuming that there is a plurality of participants other than the organizer at a specific drinking and eating party, the information processing system 1 includes the plurality of second user terminals 30. The second user terminals 30 are participant terminals used by participants other than the organizer.

Each of the second user terminals 30 includes a communication unit 31, a control unit 32, a storage 33, and a display unit 34. The communication unit 31, the control unit 32, the storage 33, and the display unit 34 included in the second user terminal 30 are physically similar to the communication unit 21, the control unit 22, the storage 33, and the display unit 24 included in the first user terminal 20. The second user terminal 30 may be any mobile terminal as long as it may transmit and receive information to and from the wallet server 10 via the network NW.

The settlement company server 40 is a server for managing an account and a credit card of a user, and is provided in a financial institution (for example, a bank, a credit union, a labor bank, etc.) and a credit card company. The settlement company server 40 includes a communication unit 41, a control unit 42, and a storage 43. The communication unit 41, the control unit 42, and the storage 43 included in the settlement company server 40 are physically similar to the communication unit 11, the control unit 12, and the storage 13 included in the wallet server 10.

In the storage 43, account information and credit card information for each of users of the wallet system are stored. Examples of the account information include a name of a user, an account number, an account balance, a deposit/withdrawal history, and the like. Examples of the credit card information include a name of a user, a credit card number, a credit card expiry date, a usage limit, a card usage history, and the like.

In the information processing system 1 configured in this way, each user owns the first user terminal 20 or one of the second user terminals 30. Then, an electronic wallet is registered for each user. In the electronic wallet, for example, four settlement methods: “A Pay”, “B Pay”, “C Pay”, and “D Pay”, are registered as a plurality of different settlement methods. “A Pay”, “B Pay”, “C Pay”, and “D Pay” may be any of settlement by a bank account, settlement by a credit card, or settlement by electronic money. Settlement by a bank account is a settlement method in which the settlement amount is withdrawn directly from the bank account. To the credit card, a bank account is linked and a use amount of the credit card is withdrawn from the bank account at a later date. To the electronic wallet, a deposit method such as a bank account and a credit card, which are methods of depositing in electronic money is linked, enabling deposit in electronic money. When the electronic money is of a prepaid type, which may be deposited by cash or the like in advance, a deposit method such as a bank account or a credit card does not need to be linked to the electronic money.

In this way, the information processing system 1 is configured to allow an organizer who has paid an expense of a specific drinking and eating party to collect money to the electronic wallet as reimbursement, for example. That is, the wallet server 10 is configured such that the expense may be split to a plurality of participants and the split bill amount may be calculated using a predetermined ratio. The organizer may make a money collection request using the electronic wallet to the wallet server 10.

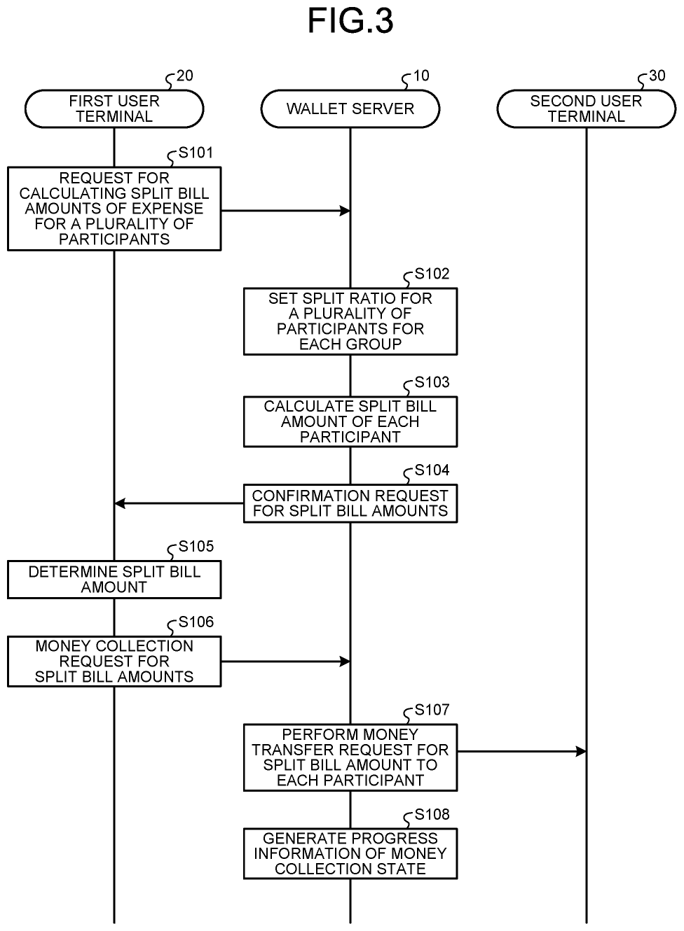

FIG. 3 is a sequence diagram illustrating a control flow for determining a split bill amount of the expense for each of a plurality of participants.

The first user terminal 20 transmits, to the wallet server 10, a request for calculating the split bill amounts of the expense for the plurality of participants (step S101). In step S101, a request for calculating the split bill amount of the expense for the members who participated in the specific drinking and eating party is output.

The wallet server 10 sets a split ratio for a plurality of participants for each of groups to which the participants belong in response to the request for calculating the split bill amount (step S102). In step S102, the wallet server 10 identifies a group to which each of the participants belongs based on the group information stored in the storage 13 of the wallet server 10. In this group information, a split ratio is set for each group.

The wallet server 10 calculates the split bill amount of each participant for the target members (step S103). In step S103, the split bill amount according to the split ratio is calculated for each of the groups to which the participants belong.

The wallet server 10 transmits, to the first user terminal 20, a confirmation request regarding the calculation result regarding the combination of the split bill amounts calculated in step S103 and the participants (step S104). In step S104, the split bill amounts calculated by the wallet server 10 based on the split ratios are proposed to the first user who is the organizer.

Upon receiving the confirmation request from the wallet server 10, the first user terminal 20 displays the calculation result of the split bill amounts included in the confirmation request on the display unit 24. In this case, the control unit 12 of the first user terminal 20 displays a screen on which the first user may perform an input operation or a selection operation. When the first user terminal 20 detects a user operation determining split bill amounts from the first user, the first user terminal 20 determines the split bill amounts (step S105). In step S105, it is possible to determine the calculation result provided in step S104 as the split bill amounts. Alternatively, it is also possible that the first user inputs amounts according to the calculation result provided in step S104, and determine the split bill amounts in step S105.

The first user terminal 20 transmits, to the wallet server 10, a money collection request for the split bill amounts based on the split bill amounts determined in step S105 (step S106).

The wallet server 10 performs a deposit request for the split bill amount to each participant in response to the money collection request from the first user terminal 20 (step S107). In step S107, a deposit request (money transfer request) is transmitted to the second user terminal 30 used by each of participants as money collection targets. The electronic wallet to be the deposit destination is the electronic wallet associated with the first user who is the organizer. That is, in step S107, money transfer from the electronic wallet associated with each of the members to the electronic wallet of the organizer is requested to the members who are participants other than the organizer, having paid the expense to be reimbursed.

Then, the wallet server 10 generates progress information of the money collection state indicating progress information for the deposit request made in step S107 (step S108). In step S108, the wallet server 10 manages progress information for each money collection request as a unit. For example, in the storage 13 of the wallet server 10, the progress information of the money collection state is stored.

Here, a participant who receives the deposit request may transfer electronic money from his/her own electronic wallet to the electronic wallet of the organizer by using the second user terminal 30 used by the participant.

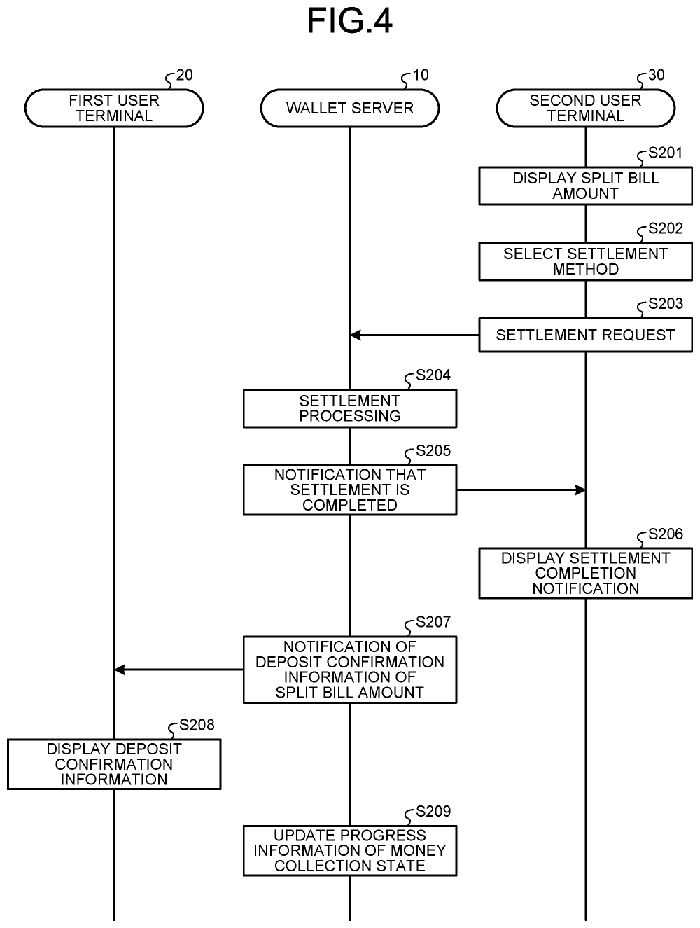

FIG. 4 is a sequence diagram illustrating money transfer processing from a participant.

Upon receiving a money transfer request from the wallet server 10, the second user terminal 30 displays the split bill amount included in the money transfer request on the display unit 34 (step S201).

The second user terminal 30 selects a settlement method used for money transfer of the split bill amount from among the plurality of settlement methods registered in the electronic wallet associated with the second user (step S202). In step S202, money transfer from, for example, “A Pay” may be selected from among the plurality of settlement methods registered in the electronic wallet of the second user.

The second user terminal 30 transmits, to the wallet server 10, a settlement request for the split bill amount using the settlement method selected in step S202 (step S203). In step S203, a settlement request for transfer of electronic money corresponding to the split bill amount is transmitted from the electronic wallet of the second user to the electronic wallet of the first user who is the organizer.

In response to the settlement request of the split bill amount from the second user terminal 30, the wallet server 10 performs settlement processing using the electronic wallet of the user (step S204). In step S204, settlement processing for money transfer from the electronic wallet associated with the second user to the electronic wallet associated with the first user is performed. This settlement processing is performed by transmitting and receiving information between the wallet server 10 and the settlement company server 40. Then, the electronic money corresponding to the split bill amount is settled from the electronic wallet of the second user, and the electronic money corresponding to the split bill amount of the participant is deposited in the electronic wallet of the first user.

When the settlement processing for the split bill amount of the participant is completed, the wallet server 10 transmits a notification indicating that the settlement is completed to the second user terminal 30 (step S205).

Upon receiving the settlement completion notification from the wallet server 10, the second user terminal 30 displays the settlement completion notification on the display unit 34 (step S206).

When the settlement processing for the split bill amount of the participant is completed, the wallet server 10 notifies the first user terminal 20 of deposit confirmation information indicating that the money transfer processing of the split bill amount of the second user is completed (step S207). The processing of step S207 may be performed at the same time as the transmission of the settlement completion notification to the second user terminal 30 in step S205.

Upon receiving the deposit confirmation information from the wallet server 10, the first user terminal 20 displays the deposit confirmation information on the display unit 24 (step S208).

Further, when the wallet server 10 transmits the settlement completion notification to the second user terminal 30 and the deposit confirmation information to the first user terminal 20, the wallet server 10 updates the progress information of the money collection state (step S209). In step S209, to the progress information of the money collection state stored in the storage 13 of the wallet server 10, information indicating that the money transfer from the second user among the plurality of money collection targets has been completed is added.

The progress information of the money collection state updated in this way may be viewed by the members who participated in the drinking and eating party. For example, progress information may be provided in response to an information confirmation request from the first user who is the organizer.

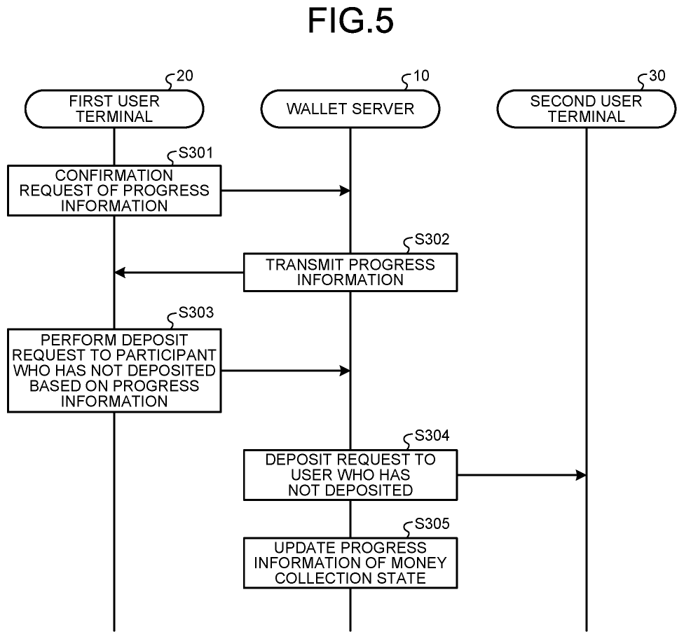

FIG. 5 is a sequence diagram illustrating a progress confirmation flow of money collection state.

The first user terminal 20 transmits a confirmation request of the progress information of the money collection state to the wallet server 10 (step S301).

In response to the confirmation request of the progress information from the first user terminal 20, the wallet server 10 refers to the storage 13 and transmits the progress information of the money collection state to the first user terminal 20 (step S302). In step S302, the progress information updated to the latest state is transmitted. In addition, when the progress information is stored in somewhere other than the storage 13, for example, in another server, the wallet server 10 acquires the progress information and then transmits the progress information to the first user terminal 20.

Based on the progress information received from the wallet server 10, the first user terminal 20 transmits, to the wallet server 10, a deposit request to a participant who has not deposited the split bill amount even when a predetermined time has passed (step S303).

The wallet server 10 performs a deposit request to the second user terminal 30 used by the user who has not deposited in response to the deposit request from the first user terminal 20 (step S304). In step S304, a participant who has not deposited is identified based on the progress information. At that time, the wallet server 10 generates reminder information for the users who have not deposited. The wallet server 10 then transmits the deposit request as reminder information to the second user terminal 30 used by the identified participant who has not deposited.

In addition, the wallet server 10 adds, to the progress information, that the reminder information indicating that the deposit request has been made to a user who has not deposited has been transmitted (step S305). In step S305, the wallet server 10 updates the progress information with information indicating that the reminder information has been transmitted.

As described above, according to the embodiment, it becomes easy to collect money from participants when an organizer pays an expense and gets the expense reimbursed.

According to the present disclosure, it will be easier for an organizer to collect money from participants when the organizer pays an expense and gets the expense pay reimbursed.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing system comprising:
a first terminal comprising a first processor comprising hardware; and
a server comprising a second processor comprising hardware, wherein
the first processor is configured to output, to the server, a calculation request for calculating a split bill amount for each user in a case where an expense is split to a plurality of users using electronic money deposited in an electronic wallet of each of the plurality of users, and
the second processor is configured to
calculate, in response to the calculation request, a split bill amount for each of the plurality of users based on user information of the plurality of users, and
output information about the calculated split bill amount to the first terminal.

2. The information processing system according to claim 1, wherein
the first terminal is an organizer terminal used by an organizer who has paid the expense to be reimbursed, and
the first processor is configured to output, based on the calculated split bill amount, a money collection request for the split bill amounts from the plurality of users to the server.

3. The information processing system according to claim 2 further comprising
a second terminal comprising a third processor comprising hardware, wherein
the second terminal is a participant terminal used by each of participants other than the organizer among the plurality of users, and
the second processor is configured to output a deposit request of the split bill amount for each of the plurality of participants to the participant terminal in response to the money collection request.

4. The information processing system according to claim 3, wherein the second processor is configured to accept deposit according to a plurality of different settlement methods associated with the electronic wallet when the second processor is configured to collects money of the split bill amount from each user.

5. The information processing system according to claim 4, wherein the second processor is configured to calculate the split bill amount while classifying the plurality of users into a first user belonging to a first group for which a split ratio for the expense is set larger and a second user belonging to a second group for which the split ratio is set smaller than the first user.

6. The information processing system according to claim 5, wherein the second processor is configured to determine to which of the first group and the second group each of the users as split targets belongs based on user information when the second processor splits an expense into the plurality of users.

7. The information processing system according to claim 6, wherein the second processor is configured to:
calculate the split bill amount based on the split ratio set for each group when the users as the split targets include users belonging to different groups; and
calculate the split bill amount evenly when the users as the split targets belong to an identical group.

8. The information processing system according to claim 7, wherein
the first processor is configured to output, to the server, progress confirmation indicating a money collection state of the split bill amounts from the plurality of users, and
the second processor is configured to
generate progress information about a money collection state indicating whether a deposit of the split bill amount for each of the plurality of users has been made, and
output, in response to the progress confirmation, the progress information to the organizer terminal.

9. The information processing system according to claim 8, wherein the second processor is configured to:
generate reminder information for a user who has not deposited for the split bill amount even when a predetermined time has passed; and
output the reminder information to the participant terminal associated with the user for which the reminder information is generated.

10. A server comprising
a processor comprising hardware, the processor being configured to:
calculate, in a case where an expense is split to a plurality of users using electronic money deposited in an electronic wallet of each of the plurality of users, a split bill amount for each of the plurality of users based on user information of the plurality of users in response to a calculation request for calculating a split bill amount for each user, and
output information about the calculated split bill amount to an organizer terminal used by an organizer who has paid the expense to be reimbursed.

11. The server according to claim 10, wherein
the processor is configured to output, in response to a money collection request for collecting the split bill amounts from the plurality of users, a deposit request of a split bill amount for each of the plurality of participants to a participant terminal used by each of participants other than the organizer among the plurality of users.

12. The server according to claim 11, wherein the processor is configured to accept deposit according to a plurality of different settlement methods associated with the electronic wallet in a case where the processor collects money of the split bill amount from each user.

13. The server according to claim 12, wherein the processor is configured to calculate the split bill amount while classifying the plurality of users into a first user belonging to a first group for which a split ratio for the expense is set larger and a second user belonging to a second group for which the split ratio is set smaller than the first user.

14. The server according to claim 13, wherein the processor is configured to accept deposit according to a plurality of different settlement methods associated with the electronic wallet in a case where the processor collects money of the split bill amount for the expense from each user.

15. The server according to claim 14, wherein the processor is configured to determine to which of the first group and the second group each of the users as split targets belongs based on user information in a case where the processor splits an expense into the plurality of users.

16. The server according to claim 15, wherein the processor is configured to:
calculate the split bill amount based on a split ratio set for each group when the users as the split targets include users belonging to different groups; and
calculate the split bill amount evenly when the users as the split targets belong to an identical group.

17. The server according to claim 16, wherein the processor is configured to:
generate progress information about a money collection state indicating whether a deposit of the split bill amount for each of the plurality of users has been made; and
output, in response to progress confirmation indicating a money collection state of the split bill amounts from the plurality of users, the progress information to the organizer terminal.

18. The server according to claim 17, wherein the processor is configured to:
generate reminder information for a user who has not deposited for the split bill amount even when a predetermined time has passed; and
output the reminder information to the participant terminal associated with the user for which the reminder information is generated.

19. A non-transitory computer-readable recording medium on which an executable program is recorded, the program causing a processor of a computer to execute:
calculate, in a case where an expense is split to a plurality of users using electronic money deposited in an electronic wallet of each of the plurality of users, a split bill amount for each of the plurality of users based on user information of the plurality of users in response to a calculation request for calculating a split bill amount for each user; and
output information about the calculated split bill amount to an organizer terminal used by an organizer who has paid the expense to be reimbursed.

20. The non-transitory computer-readable recording medium according to claim 19, wherein the program causes the processor to execute, in response to a money collection request for collecting the split bill amounts from the plurality of users, output a deposit request of a split bill amount for each of the plurality of participants to a participant terminal used by each of participants other than the organizer among the plurality of users.
